(19) United States
(12) Patent Application Publication
(10) Pub. No.: US 2007/0205256 A1
(43) Pub. Date: Sep. 6, 2007

(54) Paper processing apparatus and header card used therefor

(75) Inventors: Teruhiko Uno, Mitaka-shi (JP); Ryuuji Higashi, Yokohama-shi (JP); Takahito Shinfuku, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/512,106

(22) Filed: Aug. 30, 2006

(30) Foreign Application Priority Data
Sep. 12, 2005 (JP) 2005-263809

(51) Int. Cl. G06F 17/00; G07F 19/00; G06K 19/00

(52) U.S. Cl. 235/375; 235/379; 235/487

(57) ABSTRACT

In a paper processing apparatus including a loading unit, pickup mechanism, color detection unit, pickup control unit, discrimination unit, collecting unit, and rejecting unit, partition cards having colored areas and medium are loaded into the loading unit.

### CROSS-REFERENCE TO RELATED APPLICATIONS

This application is based upon and claims the benefit of priority from prior Japanese Patent Application No. 2005-263809, filed Sep. 12, 2005, the entire contents of which are incorporated herein by reference.

### BACKGROUND OF THE INVENTION

1. Field of the Invention

The present invention relates to a paper processing apparatus for discrimination processing of, for example, bills and the like, and a header card on which information for classifying papers to be handled, the type of card, and the like are recorded.

2. Description of the Related Art

Some conventional paper processing apparatus is designed to use a header card singly or a header card and a trailer card in combination for batch processing of a small quantity of papers. In general, a stripe, magnetic pattern, or the like for causing a detection unit to identify a header card is printed on the header card, in addition to a barcode indicating individual information of the card, a serial number, customer number, and the like. On a trailer card, a stripe or magnetic pattern for differentiating the card from the header card is printed without the above barcode or serial number. In addition, the entire surface of some trailer card is colored to improve the visibility of an operator.

In a conventional paper processing apparatus, as described in, for example, PCT (WO) 2000-503956, a header card and a trailer card are colored or different codes are printed on them to allow an operator or a discrimination unit in a discrimination apparatus to detect the types of cards. According to these conventional cards, the supply of papers cannot be stopped or resumed for each batch as needed. For this reason, if an operator wants to stop operation at a batch boundary or wants to set a time interval between batches due to limitations imposed on the paper processing apparatus, the operator manually performs such operation at a corresponding timing.

### BRIEF SUMMARY OF THE INVENTION

The present invention has been made in consideration of the above situation, and has as its object to provide a paper processing apparatus which can control paper pickup operation by using partition cards which can be easily detected.

According to the present invention, there is provided a paper processing apparatus comprising a loading unit in which one or a plurality of batches of medium are loaded in a stacked state, each batch including papers stacked for each operation unit and a partition card which is stacked on the papers and includes a card-like base material having two major surfaces and a colored area for color identification provided on at least one major surface of the card-like base material to identify the card, a pickup mechanism which picks up the medium one by one from the loading unit, a color detection unit which detects a color of the target medium placed at a front end of the loading unit in a pickup direction, a pickup control unit which controls pickup operation on the basis of detection information from the color detection unit, a discrimination unit to detect and discriminate a characteristic of the target medium, a collecting unit which collects the papers on the basis of a discrimination result obtained by the discrimination unit, and a rejecting unit which collects the paper and the partition card, which are not collected by the collecting unit, on the basis of a discrimination result obtained by the discrimination unit.

According to the present invention, there is provided a header card which is placed as a partition card at a front end of an operation unit of stacked papers when papers are loaded into a paper processing apparatus for detecting, discriminating, and stacking the papers, comprising a card-like base material having two major surfaces, a barcode area which is provided in a central portion of one major surface and on which identification information of a paper is recorded, and a colored area which is provided around the barcode area to identify a type of card.

By using the present invention, paper pickup operation can be easily controlled.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing the arrangement of an example of a paper processing apparatus according to the present invention;

FIG. 2 is a front view showing the first example of a header card used in the present invention;

FIG. 3 is a front view showing the first example of a trailer card used in the present invention;

FIG. 4 is a flowchart for color detection and pickup of a target medium;

FIG. 5 is a block diagram showing an example of a color detection unit and an example of a pickup mechanism;

FIG. 6 is a flowchart for identification of a target medium;

FIG. 7 is a flowchart for identification of a target medium;

FIG. 8 is a block diagram showing another example of the color detection unit and another example of the pickup mechanism;

FIG. 9 is a flowchart for identification of a target medium;

FIG. 10 is a flowchart for identification of a target medium;

FIG. 11 is a front view showing the second example of a header card used in the present invention;

FIG. 12 is a front view showing the second example of a trailer card used in the present invention;

FIG. 13 is a front view showing the third example of a header card used in the present invention;

FIG. 14 is a front view showing the third example of a trailer card used in the present invention;

FIG. 15 is a front view showing the fourth example of a header card used in the present invention; and

FIG. 16 is a front view showing the fourth example of a trailer card used in the present invention.

### DETAILED DESCRIPTION OF THE INVENTION

An embodiment of the present invention will be described below with reference to the views of the accompanying drawing.

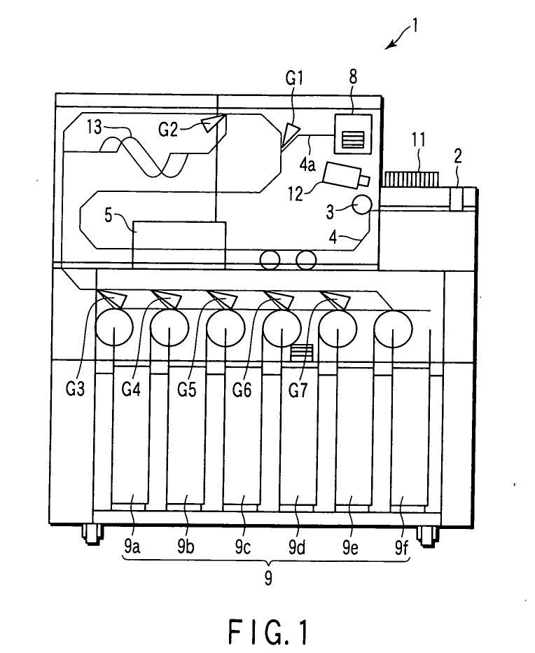

FIG. 1 is a schematic view showing the arrangement of a banknote processing apparatus 1 (to be simply referred to as the processing apparatus 1 hereafter) as an example of a paper processing apparatus according to the present invention, which checks, for example, banknotes (papers) sent from a plurality of banks and bind them for reuse.

The processing apparatus 1 includes a loading unit 2 in which a plurality of banknotes in a stacked state with header cards (to be described later) being inserted between them are to be loaded. On the obverse and reverse surfaces of a header card, the same combinations of color patterns are printed respectively as machine-readable identification symbols unique to the card.

As processing to be performed before the loading of banknotes into the processing apparatus 1, the above one header card can be stacked on medium corresponding to one processing unit (to be referred to as a batch hereinafter), e.g., one group of banknotes of the same denomination sent from branch banks. In addition, as medium of the next batch, banknotes and a header card can be stacked on the above medium.

In addition, depending on operation, a header card and a trailer card can be respectively placed at the front and rear ends of a batch. A case wherein both a header card and a trailer card are used will be described below. Note that the numbers of banknotes of the respective batches are not necessarily the same. In this manner, stacked medium 11 comprising banknotes corresponding to the number of batches that can be loaded at once, header cards each of which partitions the front end of the corresponding batch from others, and trailer cards each of which partitions the rear end of the corresponding batch from others are loaded into the processing apparatus 1. At this time, the operator inputs, as data associated with the banknotes of each batch, a bank name, a bank branch name, the denomination of banknotes, the number of banknotes, and the like in association with a barcode on a header card inserted for each batch. The batch data input in the preprocessing in this manner are used for collation with the counting result obtained by the processing apparatus 1 in postprocessing.

The rear side of the loading unit 2 is provided with a pickup mechanism 3 which picks up the header card, banknotes, and trailer card (which may sometimes be generically termed as medium hereinafter), which are loaded into the loading unit 2, one by one from the foremost end of the batch. The pickup mechanism 3 is designed to hold a paper vertically or horizontally and pick up medium at a predetermined pitch upon reception of driving force from a motor.

The paper is defined as a paper-like article such as a paper and synthetic resin paper from here on.

A color detection unit 12 which detects the color of the target medium placed at the front end of the loading unit 2 is provided between the loading unit 2 and the pickup mechanism 3.

The color detection unit 12 includes one or more color sensors. The color detection unit 12 observes. the color information of the start paper every time it is picked up, and communicates the color information of each paper to a pickup control unit (not shown). Assume that in this apparatus, two color sensors 12A and 12B are mounted in the color detection unit 12.

A convey path 4 which conveys the target medium, picked up by an attraction roller and the like, through inside the processing apparatus 1 extends on the downstream side of the pickup mechanism 3. A convey belt (not shown) and driving pulleys are arranged on the convey path 4. A target medium is conveyed at a predetermined speed through the convey path 4 by causing the convey belt to travel using a driving motor (not shown).

A discrimination unit 5 for detecting and discriminating the characteristic of a target medium conveyed through the convey path 4 is provided on the convey path 4 extending from the pickup mechanism 3. The discrimination unit 5 can be provided with a detection unit (not shown) which detects, for example, the characteristic of a target medium, a detection information processing unit (not shown) which processes the detected information about the target medium which is supplied from the detection unit, and the like.

Six gates G1 to G7 are sequentially arranged on the convey path 4 on the downstream side of the discrimination unit 5. The gates G1 to G7 are switched to direct the target medium to a predetermined processing unit under the control of a control unit (not shown) on the basis of the detection result obtained by the discrimination unit 5.

The gate G1 placed immediately behind the discrimination unit 5 is provided at a position to make the convey path 4 branch off to a rejection convey path 4a. The gate G1 is switched to cause a rejected note detected not as an authentic banknote through the discrimination unit 5 or a header card to branch off to the rejection convey path 4a. A rejection collecting unit 8 (rejecting unit) is provided at the end of the rejection convey path 4a. Rejected notes and header cards are stacked in the rejection collecting unit 8 in the order in which they are picked up without being changed in their postures as they were picked up by the pickup mechanism 3, i.e., without having their obverse and reverse surfaces reversed. For example, a header card which is loaded into the loading unit 2 with its obverse surface facing up and picked up is stacked in the rejection collecting unit 8 with its obverse surface facing up. In addition to such rejected notes and header cards, banknotes picked up in a stacked state, banknotes and header cards picked up in a stacked state, header cards picked up in a stacked state, trailer cards, and the like are stacked in the rejection collecting unit 8.

The paper determined as authentic by the discrimination unit 5 further travels on the convey path 4, and it is discriminated on the basis of direction information from the discrimination unit 5 whether the paper is to travel to a reversing unit 13 through the next gage G2 or to further travel without passing through the reversing unit 13. The reversing unit 13 is a mechanical unit capable of reversing, for example, the obverse and reverse surfaces of a paper or its forward and backward orientations. The reversing unit 13 can adjust papers supplied in four different directions (obverse/forward, obverse/backward, reverse/forward, and reverse/backward) to one direction (e.g., obverse/forward) or two directions (e.g., obverse/forward and obverse/backward). The reversing unit 13 can be omitted as needed.

First to sixth collecting units 9a to 9f (to be generically termed as a collecting unit 9 hereinafter, as needed) for collecting and binding papers are arranged at positions where the convey path 4 is made to branch off by the gates G3 to G7 provided along the convey path 4 on the downstream side of the gate G2. The collecting unit 9 collects and binds only authentic notes of the banknotes, other than rejected notes guided through the gate G1, which can be reused. For example, the first and second collecting units 9a and 9b each are used to collect and bind 100 authentic notes with their obverse surfaces facing up. The third and fourth collecting units 9c and 9d each are used to collect and bind 100 authentic notes with their reverse surfaces facing up. The authentic notes bound by the collecting unit 9 are delivered outside the apparatus through a conveyor (not shown) and the like to be reused.

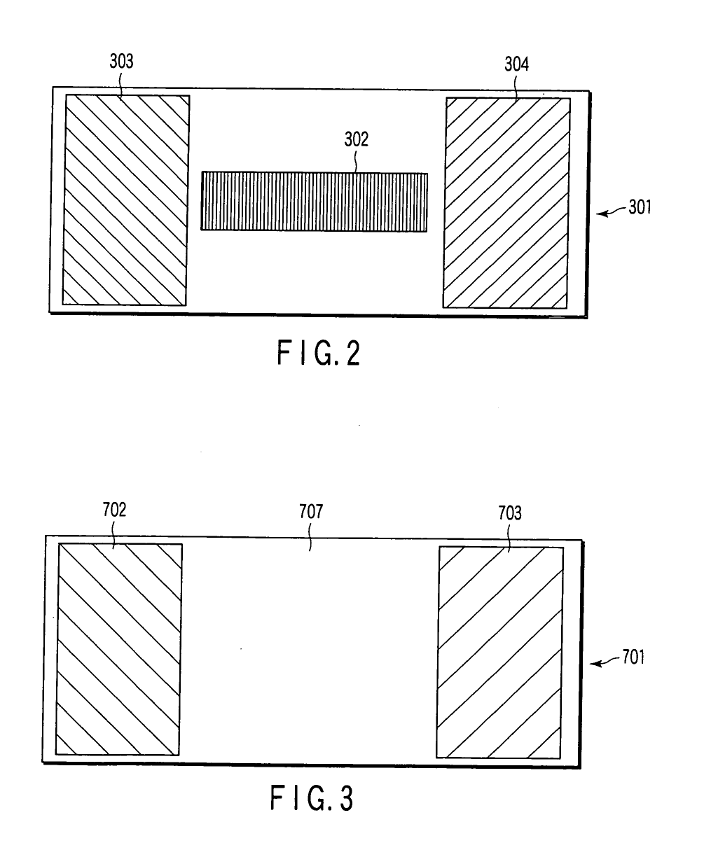

FIGS. 2 and 3 respectively show the first examples of a header card and trailer card used in the present invention.

In this case, each target medium is rectangular in shape and conveyed in a direction perpendicular to the long side.

As shown in FIG. 2, a header card 301 is designed such that barcode areas 302 each having a size of, for example, 40×20 cm on which the identification information of the paper is recorded are provided in central portions of the two major surfaces of a rectangular card base material 307 having a size of, for example, 160×85 cm. A first colored area 303 having a rectangular shape with a size of, for example, 40×60 cm and a first color is provided on one end of each of the two major surfaces in the longitudinal direction of the card base material 307, e.g., the left end in FIG. 2. On the other hand, a second colored area 304 having the same size and a second color is provided on the other end of each of the two major surfaces in the longitudinal direction of the card base material 307, e.g., the right end in FIG. 2. In this manner, these colored areas are provided on the two major surfaces so as to have the same constructions on the obverse and reverse surfaces. In addition, for example, barcode numerals or the like (not shown) can be written on a card so as to identify its top and bottom. The thickness of a header card differs from that of a banknote to facilitate identification of the card.

The colors of colored areas to be used in the present invention are not limited to those having absorption in the visible light range, and any colors can be used as long as they can be detected by the color detection unit. Colors having absorption in the ultraviolet, near infrared, and infrared ranges can be used. In addition, the first and second colored areas may have the same or different colors.

As shown in FIG. 3, a trailer card 701 has the same arrangement as that of the header card 301 except that the barcode area 302 is not provided, and first and second colored areas 702 and 703 having a color combination different from the combination of the first and second colors are provided on a card-like base material 707 instead of the first and second colored areas 303 and second colored area 304.

In this case, the colored areas are provided on the two major surfaces of the card base material. In the present invention, however, it suffices if the above colored area is provided at least on one major surface of a card base material. Note that if colored areas are formed on the two major surfaces of a card base material, the card can be used regardless of whether the obverse and reverse surfaces of the card are reversed.

As a method of selecting colors as characteristics of a header card and trailer card, it is preferable to use a method of using colors different from those used for media as processing targets, e.g., securities. This is because, reducing the similarity between the color of cards and that of securities makes it possible to prevent determination errors, e.g., erroneously determining a header card as a medium. Take a bill which is a kind of securities as an example. The obverse surface of a US dollar bill is a two-color print with a green stamp printed on black ink as a base color. The reverse surface of the bill is a one-color print with a dark green. When such monotonous bills are handled as media, identification colors for header cards and trailer cards may be selected from a wide range, and primary colors such as red and blue may be used. As described above, however, red and blue writing tools and inks are widely used, and hence are thought to lead to determination errors. It is therefore preferable to use colors which are not used for general writing tools and stamps, e.g., yellow, purple, and orange.

In many cases, different colors are used for different denominations in consideration of the visibility of users. For example, in the case of euro notes, the colors in Table 1 are used as base colors for the respective denominations.

TABLE 1

| Denomination | | Underlying color |
|---|---|---|
| 5 | euro | Gray |
| 10 | euro | Red |
| 20 | euro | Blue |
| 50 | euro | Orange |
| 100 | euro | Green |
| 200 | euro | Yellow |
| 500 | euro | Purple |

In such a case, colors need to be carefully selected for a header card and a trailer card. Using a plurality of color sensors which can respectively detect different colors makes it possible to prevent determination errors. For example, referring to FIG. 2, if yellow and orange are respectively selected for the first and second colored areas 303 and 304, the cards can be detected almost without failure.

A registration sequence for the color information of a card will be described next.

First of all, a header card to be registered is set in the loading unit 2, and its color is registered by using the color sensors 12A and 12B. Each of the color sensors 12A and 12B comprises, for example, a combination of light sources of three colors and photodiode light-receiving units, and registers the color tone of the header card on the basis of the reflectance ratios between the three color light sources with respect to the color on the header card. The color sensors 12A and 12B are respectively provided at positions to detect the colors of predetermined areas on each target medium, i.e., the first and second colored areas of each of a header card and a trailer card. Since the two color sensors 12A and 12B are used, the colors of two discrete or continuous portions of a paper can be detected.

For example, referring to FIG. 2, if the colored area 303 is yellow and the colored area 304 is orange, the reflectances of the color sensors 12A and 12B with respect to the three color light sources are obtained as follows:

TABLE 2

| Detection | Red light | Green light | Blue light |
|---|---|---|---|
| sensor | source | source | source |
| 103A | 70% | 70% | 10% |
| 103B | 70% | 40% | 10% |

When color registration is complete, reflectance ranges for the determination of a header card is set. With respect to the reflectances registered in Table 2, the following acceptable ranges are set:

TABLE 3

| Detection | Red light | Green light | Blue light |
|---|---|---|---|
| sensor | source | source | source |
| 103A | 65-75% | 65-75% | 5-15% |
| 103B | 65-75% | 35-45% | 5-15% |

If all the reflectances with respect to the respective light sources of the color sensors 12A and 12B fall within the ranges in Table 3, the target card can be identified as a header card.

Similar registration operation is executed for a trailer card.

In the case of the trailer card shown in FIG. 3, for example, green and blue can be selected for the first and second colored areas, respectively.

In this case, reflectances with respect to the three color light sources of the color sensors 12A and 12B are obtained as follows:

TABLE 4

| Detection | Red light | Green light | Blue light |
|---|---|---|---|
| sensor | source | source | source |
| 103A | 10% | 70% | 10% |
| 103B | 10% | 10% | 70% |

When color registration is complete, reflectance ranges for the determination of a trailer card are set.

The following acceptable ranges are set with respect to the reflectances registered in Table 4:

TABLE 5

| Detection | Red light | Green light | Blue light |
|---|---|---|---|
| sensor | source | source | source |
| 103A | 5-15% | 65-75% | 5-15% |
| 103B | 5-15% | 5-15% | 65-75% |

If all the reflectances with respect to the respective light sources of the color sensors 12A and 12B fall within the ranges in Table 5, the target card can be identified as a trailer card.

Note that the above registration operation can be executed again when the target medium is changed or the lots of header cards and trailer cards are changed. In addition, the user can change the acceptable ranges to optimal numerical values while checking the deterioration state of a card in actual operation. In this manner, registration operation can be executed easily and accurately.

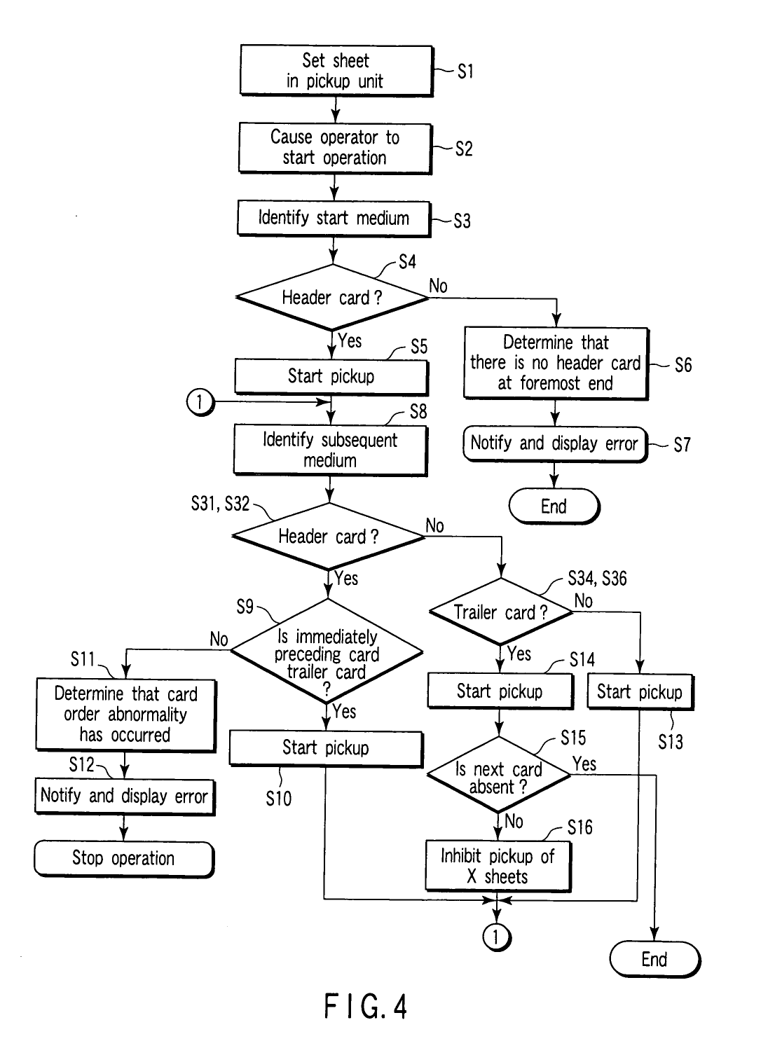

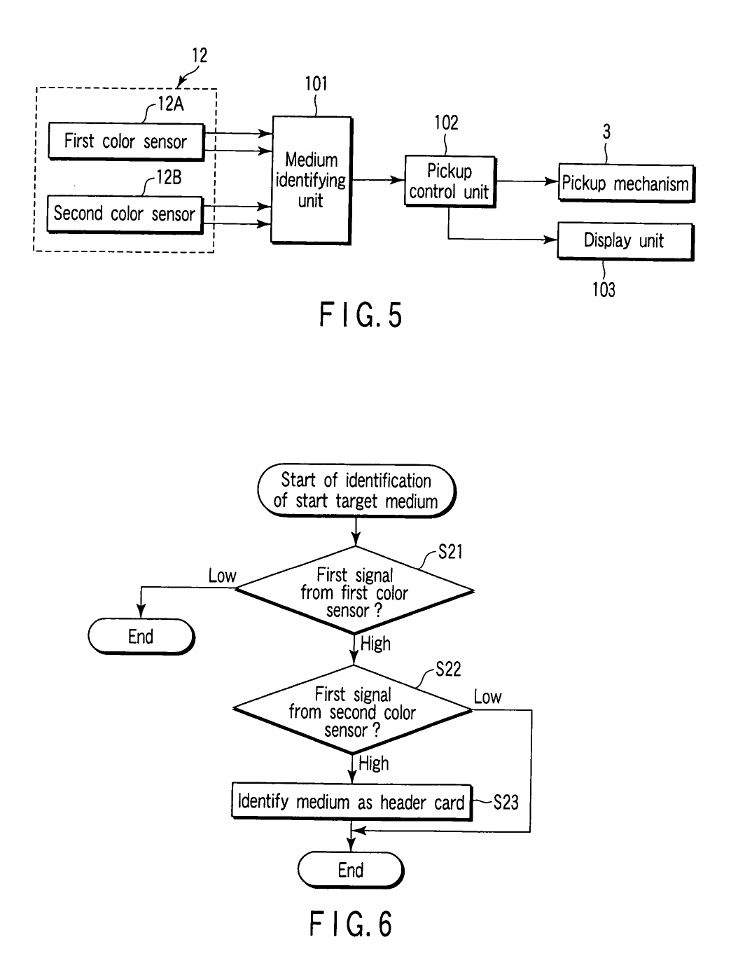

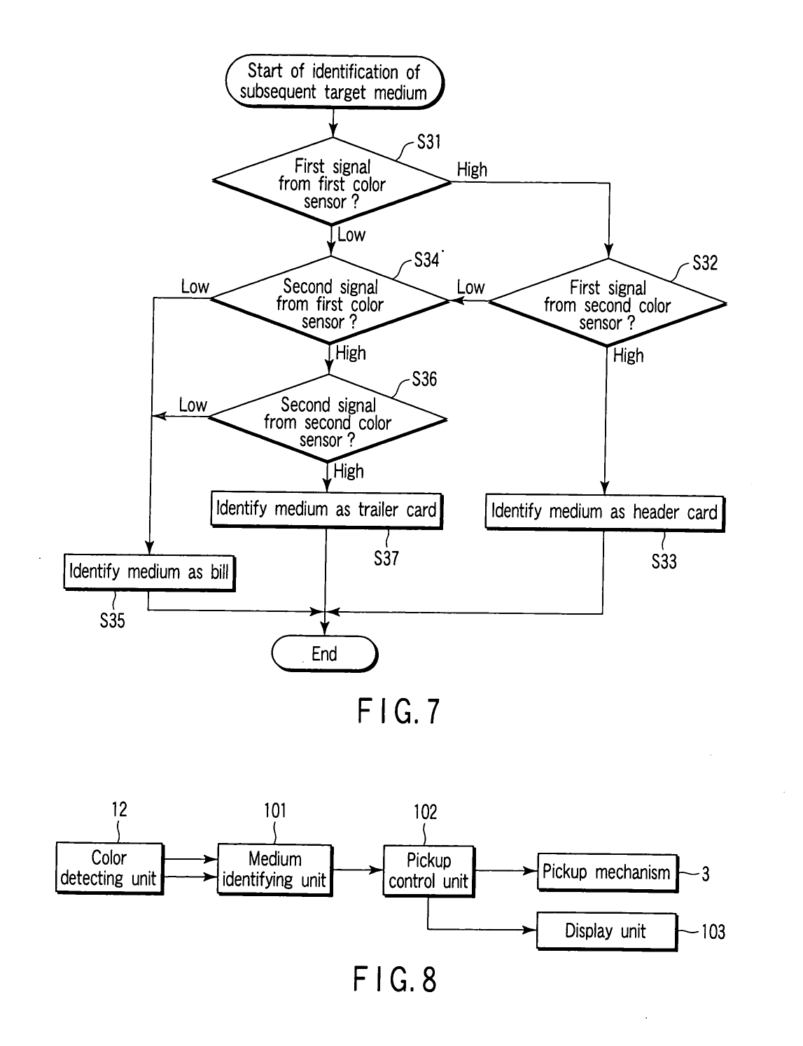

An example of a batch processing system using the header card shown in FIG. 2 and the trailer card shown in FIG. 3 will be described with reference to the flowchart of FIG. 4 for color detection and the pickup of a target medium, the block diagram of FIG. 4 showing the color detection unit and pickup mechanism, and the flowcharts of FIGS. 6 and 7 for the identification of the target medium.

First of all, a plurality of batches, each comprising a header card, stacked papers, and a trailer card, are supplied in one lot to the loading unit 2 of the processing apparatus 1 (S1).

The operator then gives an instruction to start operation through an operation unit (not shown) (S2). Upon reception of this instruction, identification of the target medium at the head of the loading unit 2 is started (S3).

For example, the reflectances of the first colored area which are detected by the first color sensor 12A are sent as pieces of detection information to a medium identifying unit 101, which in turn discriminates whether the pieces of information are the first signal indicating a header card, i.e., fall within the acceptable ranges shown in Table 3 (S21), as shown in FIG. 6. If the pieces of information do not fall within the acceptable ranges, the processing is terminated. If all the pieces of information fall within the acceptable ranges, the pieces of reflectance information of the second colored area which are detected by the second color sensor 12B are sent to the medium identifying unit 101, which in turn discriminates whether the pieces of information are the first signal indicating a header card, i.e., fall within the acceptable ranges shown in Table 3 (S22). If the pieces of information do not fall within the acceptable ranges, the processing is terminated. If the pieces of information fall within the acceptable ranges, the target medium is identified as a header card (S23).

A pickup control unit 102 determines on the basis of the identification result on the target medium whether the first target medium is a header card (S4).

If the target medium is a header card, it is determined that the pickup mechanism 3 is to start picking up the target medium. Upon reception of this determination result, the pickup control unit 102 issues a pickup start instruction to the pickup mechanism 3 (S5).

If the target medium is not a header card, it is confirmed that the target medium is a medium other than a header card (S6), and a pickup operation error due to a setting error or abnormality in the color sensors is determined. Upon reception of this determination result, the pickup control unit communicates an error message to a display unit 103 to display the corresponding information (S7).

When pickup operation is started, the color sensors 12A and 12B sequentially perform color detection with respect to the subsequent target medium located at the end of the loading unit 2 in the pickup direction every time the target medium is picked up, and identify the subsequent target medium.

For example, the reflectances of the first colored area which are detected by the first color sensor 12A are sent as pieces of reflectance information to the medium identifying unit 101. As shown in FIG. 7, it is discriminated whether these pieces of reflectance information are the first signal indicating a header card, i.e., fall within the acceptable ranges shown in Table 3 (S31). If all the pieces of reflectance information fall within the acceptable ranges, the medium identifying unit 101 determines whether the pieces of reflectance information of the second colored area which are detected by the second color sensor 12B are the first signal indicating a header card, i.e., fall within the acceptable ranges shown in Table 3 (S32). If these pieces of reflectance information fall within the acceptable ranges, the target medium is identified as a header card (S33). If the pieces of reflectance information do not fall within the acceptable ranges associated with the first signal, and the pieces of reflectance information detected by the first color sensor 12A are not the first signal, i.e., do not fall within the acceptable ranges shown in Table 3, it is discriminated whether the pieces of reflectance information detected by the first color sensor 12A and sent to the medium identifying unit 101 is the second signal indicating a trailer card i.e., fall within the acceptable ranges shown in Table 5 (S34). If these pieces of reflectance information are not the second signal, the target medium is identified as a bill (S35). If the pieces of reflectance information are the second signal, it is discriminated whether the pieces of reflectance information detected by the second color sensor 12B and sent to the medium identifying unit 101 are the second signal indicating a trailer card, i.e., fall within the acceptable ranges shown in Table 5 (S36). If the pieces of reflectance information are not the second signal, the target medium is identified as a bill. If the pieces of reflectance information are the second signal, the target medium is identified as a trailer card (S37).

If it is discriminated as the result of the above identification processing that the subsequent target medium is a header card, it is discriminated whether the immediately preceding medium is a trailer card (S9).

If the immediately preceding medium is a trailer card, pickup operation is started (S10).

If the immediately preceding medium is not a trailer card, it is identified that card order abnormality has occurred (S11). This identification result is notified to the pickup mechanism 3. The pickup mechanism 3 then communicates an error message to the display unit 103 to display the corresponding information (S12).

If it is discriminated as the result of the above identification processing that the subsequent target medium is neither a header card nor a trailer card, pickup operation is started (S13).

If it is discriminated as the result of the above identification processing that the subsequent target medium is a trailer card, the pickup of the trailer card is started (S14). It is then checked whether there is any next target medium, and the corresponding information is sent to the pickup control unit 102 (S15). If there is no next target medium, the pickup control unit 102 determines that target medium pickup operation by the pickup mechanism is to be stopped, and issues a pickup stop instruction to the pickup mechanism 3. The series of batch processing is then terminated. If there is a next target medium, the pickup control unit 102 determines that the pickup of X media is to be stopped, and issues a resume instruction (S16) after stopping the pickup of medium by the pickup mechanism for a period of time corresponding to the pickup of, for example, X media.

Note that in the above batch processing system has exemplified the system using two color sensors. However, in the present invention, one color sensor can be used.

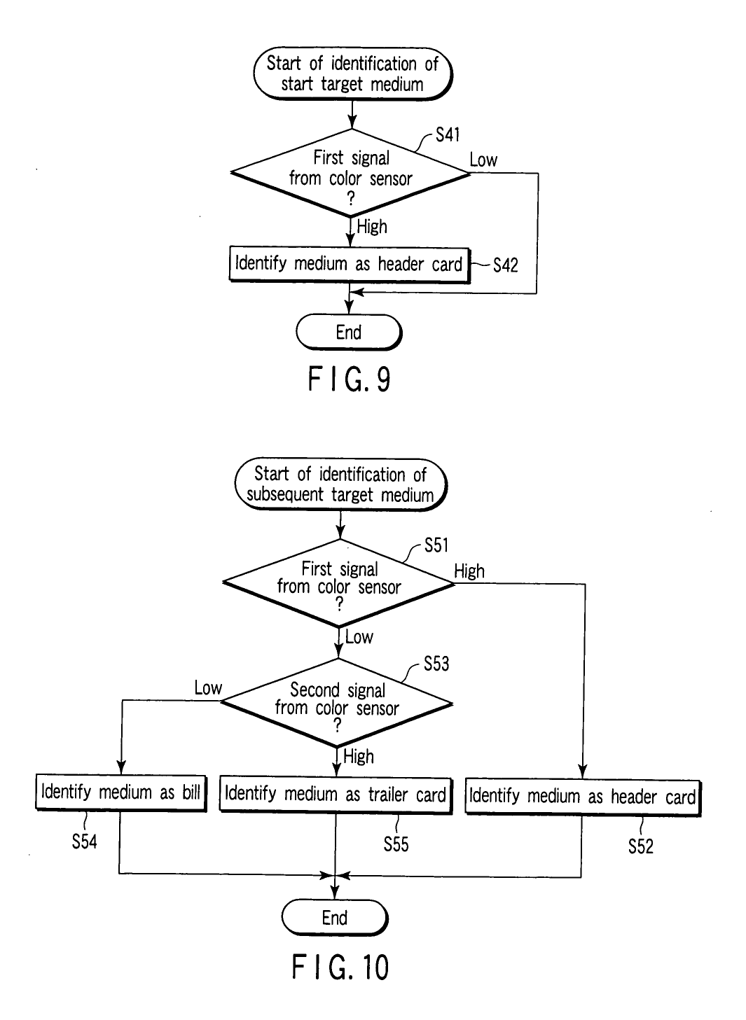

FIG. 8 is a block diagram showing a color detection unit using one color sensor and a pickup mechanism. FIG. 9 is a flowchart for identifying a start target medium when one color. sensor is used. FIG. 10 is a flowchart for identifying a subsequent target medium when one color sensor is used.

In identification of the start target medium (S3) in FIG. 4, as shown in FIGS. 8 and 9, when one color sensor is used, the reflectances of the first colored area which are detected by the color detection unit 12 using the color sensor are sent as pieces of detection information to the medium identifying unit 101, which in turn discriminates whether the pieces of information are the first signal indicating a header card, i.e., fall within the acceptable ranges shown in Table 3 (S41). If the pieces of information do not fall within the acceptable ranges, the processing is terminated. If all the pieces of information fall within the acceptable ranges, the target medium can be identified as a header card (S42).

In identification of the subsequent target medium (S8) in FIG. 4, as shown in FIGS. 8 and 10, for example, the reflectances of the first colored area which are detected by the color sensor are sent as pieces of detection information to the medium identifying unit 101, which in turn discriminates whether the pieces of information are the first signal indicating a header card, i.e., fall within the acceptable ranges shown in Table 3 (S51). If all the pieces of information fall within the acceptable ranges, the target medium is identified as a header card (S52). If the reflectances of the first colored area do not fall within the acceptable ranges associated with the first signal indicating a header card, or the pieces of reflectance information detected by the first color sensor 12A are not the first signal, i.e., do not fall within the acceptable ranges shown in Table 3, it is discriminated whether the pieces of reflectance information detected by the first color sensor 12A and sent to the medium identifying unit 101 are the second signal indicating a trailer card, i.e., fall within the acceptable ranges shown in Table 5 (S53). If the pieces of reflectance information detected by the first color sensor 12A are not the second signal, the target medium is identified as a bill (S54). If the pieces of information are the second signal, the target medium can be identified as a trailer card (S55).

When the paper processing apparatus of the present invention is used, paper pickup operation can be controlled for each operation unit by using partition cards which can be easily detected. For example, processing of one batch can be started by detecting a header card, and can be ended by detecting a trailer card. When a jam occurs in the paper processing apparatus, mixing of papers between different batches can be prevented. In addition, since the color information of a header card and trailer card can be arbitrarily registered, even if a header card and trailer card are changed as the type of paper is changed, such a change can be quickly handled.

Another example of a header card according to the present invention and another example of a trailer card which can be used together with the header card will be described below.

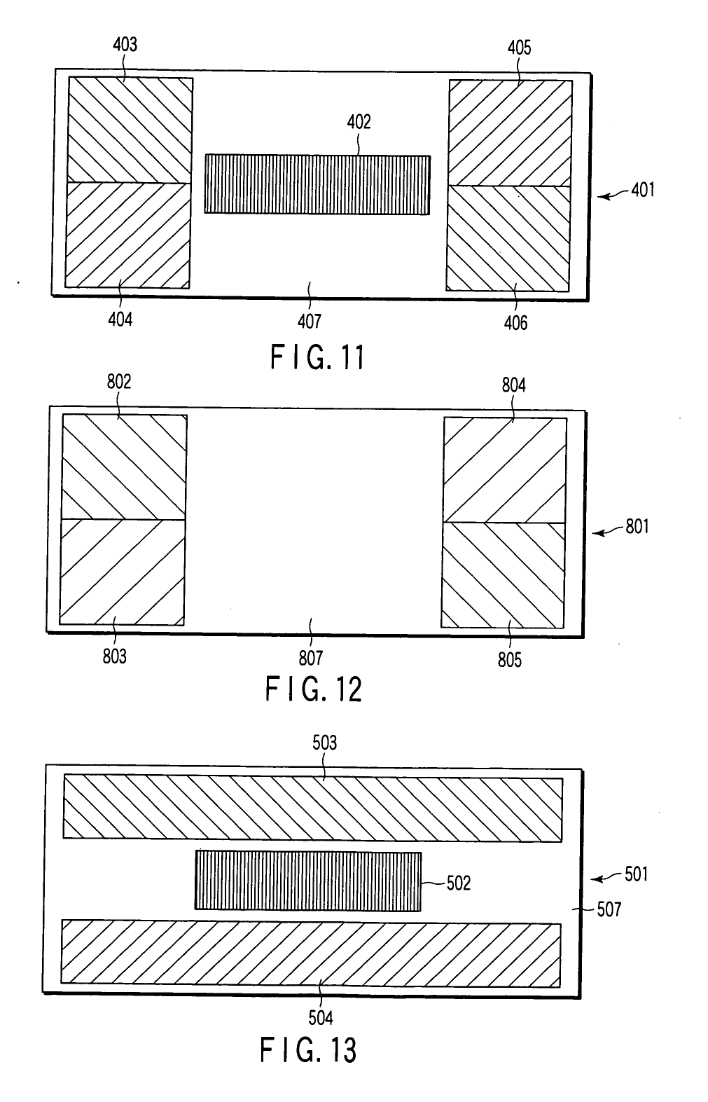

FIGS. 11 and 12 show the second examples of a header card and trailer card used in the present invention.

In this case, a target medium is rectangular in shape, and is conveyed in a direction perpendicular to its long side.

As shown in FIG. 11, a header card 401 has the same arrangement as that of the header card shown in FIG. 2 except that a first colored area 403 and a second colored area 404 obtained by vertically dividing the first colored area 303 into two parts are respectively provided on the upper and lower portions on the left end portion of each of the two major surfaces of a card-like base material 407 in FIG. 11 instead of the first colored area 303, and a third colored area 405 and a fourth colored area 406 obtained by vertically dividing the second colored area 304 into two parts are respectively provided on the upper and lower portions on the right end portion of each of the two major surfaces in FIG. 11 instead of the second colored area 304. On the header card 401, the patterns of the first, second, third, and fourth colored areas 403, 404, 405, and 406 are point-symmetrically arranged so as to have the same constructions on the obverse and reverse surfaces. Assume that the first and second color sensors are set to detect the upper colored areas, and the first and fourth colored areas 403 and 406 have the same color, and the second and third colored areas 404 and 405 have the same color. In this case, even if the top and bottom and the obverse and reverse surfaces of a header card are reversed, the first and second colored areas can always be detected by the first and second color sensors, respectively.

FIG. 12 shows an example of a trailer card which can be used together with the header card 401.

As shown in FIG. 12, a trailer card 805 has the same arrangement as that shown in FIG. 11 except that the barcode areas 402 are not formed on the two major surfaces of a card base material 807, and the combination of the colors of first, second, third, and fourth colored areas 802, 803, 804, and 805 is different from that of the first, second, third, and fourth colored areas 403, 404, 405, and 406.

That the combinations of colors differ means that a given combination of first to fourth colors does not perfectly coincide with another combination of colors, and include a case wherein only one color of the given combination of colors differs from another combination of colors, and a case wherein the order of the colors of a given combination differs from that of another combination.

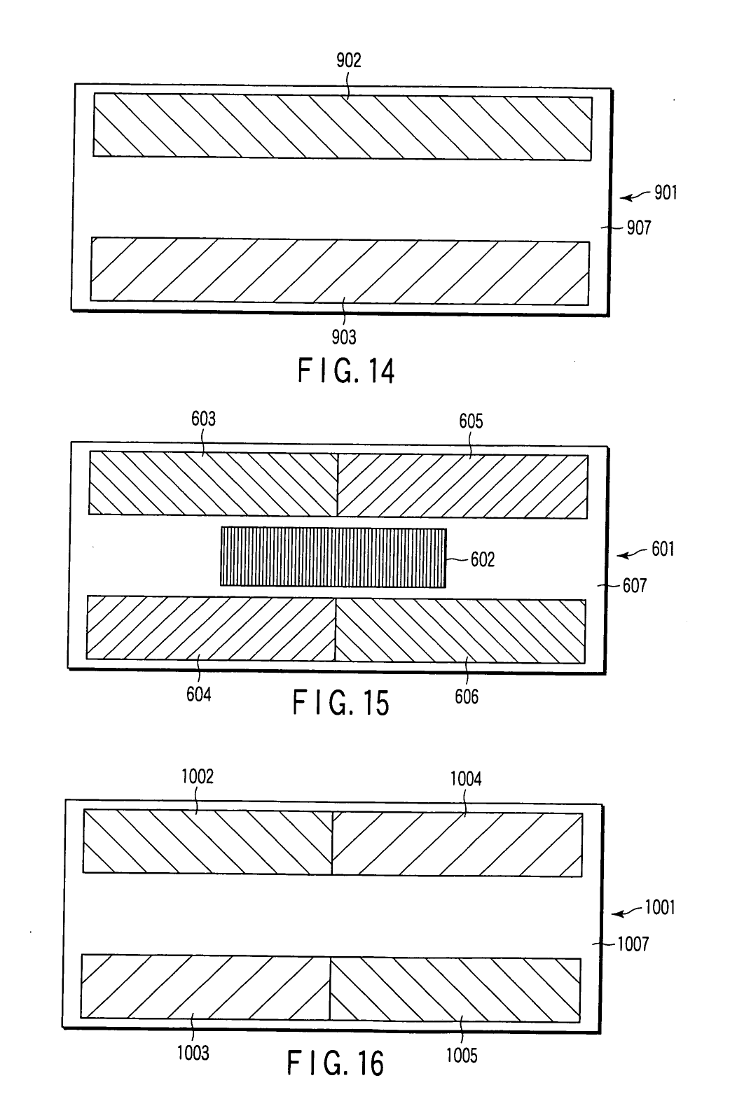

FIGS. 13 and 14 respectively show the third examples of a header card and trailer card used in the present invention.

In this case, a target medium is rectangular in shape, and is conveyed in a direction parallel to its long side.

As shown in FIG. 13, barcode areas 501 each having a size of, for example, 40×20 cm on which the identification information of the paper is recorded are provided in central portions of the two major surfaces of a rectangular card-like base material 507 having a size of, for example, 160×85 cm. A first colored area 503 having a rectangular shape with a size of, for example, 140×20 cm and a first color is provided on one end of each of the two major surfaces in the width direction of the card base material 507, e.g., the upper end in FIG. 13. On the other hand, a second colored area 504 having the same size and a second color is provided on the other end of each of the two major surfaces in the longitudinal direction of the card base material 507, e.g., the lower end in FIG. 13. In this manner, these colored areas are provided on the two major surfaces so as to have the same constructions on the obverse and reverse surfaces. In addition, for example, barcode numerals or the like (not shown) can be written on a card so as to identify its top and bottom.

As shown in FIG. 14, a trailer card 901 has the same arrangement as that of the header card 501 except that the barcode area 502 is not provided, and first and second colored areas 902 and 903 having a color combination different from the combination of the first and second colors are provided on a card-like base material 907 instead of the first and second colored areas 503 and second colored area 504.

FIGS. 15 and 16 respectively show the fourth examples of a header card and trailer card used in the present invention.

In this case, a target medium is rectangular in shape, and is conveyed in a direction parallel to its long side.

As shown in FIG. 15, a header card 601 has the same arrangement as that of the header card shown in FIG. 13 except that a first colored area 603 and a third colored area 604 obtained by horizontally dividing the first colored area 502 in FIG. 13 into two parts are respectively provided on the left and right portions on the upper end portion of each of the two major surfaces of a card-like base material 607 in FIG. 15 instead of the first colored area 503 in FIG. 13, and a third colored area 604 and a fourth colored area 606 obtained by horizontally dividing the second colored area 504 in FIG. 13 into two parts are respectively provided on the left and right portions on the lower end portion of each of the two major surfaces in FIG. 15 instead of the second colored area 504. On the header card 601, the patterns of the first, second, third, and fourth colored areas 603, 604, 605, and 606 are point-symmetrically arranged so as to have the same constructions on the obverse and reverse surfaces. Assume that the first and second color sensors are set to detect the upper colored areas, and the first and fourth colored areas 603 and 606 have the same first color, and the second and third colored areas 604 and 605 have the same second color. In this case, even if the top and bottom and the obverse and reverse surfaces of a header card are reversed, the first and second colored areas can be detected by the first and second color sensors, respectively.

FIG. 16 shows an example of a trailer card which can be used together with the header card 601.

As shown in FIG. 16, a trailer card 1001 has the same arrangement as that shown in FIG. 15 except that the barcode areas 602 are formed on the two major surfaces of a card base material 1007, and the combination of the colors of first, second, third, and fourth colored areas 1002, 1003, 1004, and 1005 is different from that of the first, second, third, and fourth colored areas 603, 604, 605, and 606.

Detecting the colored areas of two colors with two color sensors in each of the above examples of the header cards and trailer cards makes it possible to prevent a target medium from being erroneously determined as a card when the target medium is intentionally or accidentally colored. For example, in some cases, graffiti is written on securities with a red or blue pen and a stamp which should be placed on a band is erroneously placed on a security. In such a case, since identical colors are rarely observed in a plurality of portions, setting two or more detection areas is effective.

The color sensors 12A and 12B are preferably placed at positions where they can detect a medium having the minimum size of the medium which can be processed by the apparatus of the present invention. Otherwise, when a small medium is placed at the front end of the loading unit, there is a tendency that the medium cannot be detected but the subsequent medium is detected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper processing apparatus comprising:
a loading unit loading one or a plurality of batches of medium in a stacked state, each batch including papers stacked for each operation unit and a partition card which is stacked on the papers and includes a card-like base material having two major surfaces and a colored area for card identification provided on at least one major surface of the card-like base material to identify the card;
a pickup mechanism picking up the medium one by one from the loading unit;
a color detection unit detecting a color of the target medium placed at a front end of the loading unit in a pickup direction;
a pickup control unit which controls pickup operation on the basis of detection information from the color detection unit;
a discrimination unit detecting and discriminate a characteristic of the target medium;
a collecting unit collecting the papers on the basis of a discrimination result obtained by the discrimination unit; and
a rejecting unit collecting the paper and the partition card, which are not collected by the collecting unit, on the basis of a discrimination result obtained by the discrimination unit.

2. An apparatus according to claim 1, wherein the colored area has a color having absorption in light range selected from the visible light, the ultraviolet, near infrared, and infrared ranges.

3. An apparatus according to claim 1, wherein the partition card is a header card stacked on a front end of the stacked papers in a pickup direction and including a card-like base material having the two major surfaces, a barcode area provided in a central portion of at least one major surface and having recorded identification information of the paper, and a colored area provided around the barcode area to identify a type of card.

4. An apparatus according to claim 3, wherein a trailer card including a card-like base material having two major surfaces and a colored area is further provided on at least one major surface to identify a type of card is stacked as the partition card on a rear end of the stacked papers in the pickup direction.

5. An apparatus according to claim 1, wherein the colored area includes a first colored area having a first color and a second colored area having a second color, and the color detection unit comprises a first color detection unit to detect the first color and a second color detection unit to detect the second color.

6. A header card placed as a partition card at a front end of an operation unit of stacked papers when papers are loaded into a paper processing apparatus for detecting, discriminating, and stacking the papers, comprising
a card-like base material having two major surfaces, a barcode area provided in a central portion of one major surface and having recorded identification information of a paper, and a colored area provided around the barcode area to identify a type of card.

7. A card according to claim 6, wherein the colored area has a color having absorption in light range selected from the visible light, the ultraviolet, near infrared, and infrared ranges.

8. A card according to claim 6, wherein the colored area includes a first colored area having a first color and a second colored area having a second color.
